(19) United States
(12) Patent Application Publication
(10) Pub. No.: US 2005/0220295 A1
(43) Pub. Date: Oct. 6, 2005

(54) IP telephone device, method of initial setting of the same and computer-readable recording medium

(75) Inventor: Tsuneyuki Koikeda, Hamamatsu-shi (JP)

Correspondence Address: PILLSBURY WINTHROP SHAW PITTMAN LLP, 725 S. FIGUEROA STREET, SUITE 2800, LOS ANGELES, CA, 90017, US

(73) Assignee: YAMAHA CORPORATION, Hamamatsu-shi (JP)

(21) Appl. No.: 11/097,843

(22) Filed: Mar. 30, 2005

(30) Foreign Application Priority Data
Apr. 1, 2004 (JP) P2004-109075

(51) Int. Cl. H04M 7/00; H04L 12/66

(52) U.S. Cl. 379/900; 370/352

(57) ABSTRACT

An IP telephone device is provided and has a storage unit which stores a plurality of initial setup data corresponding to respective providers, an input unit which input a telephone number, a selection unit which specifies a provider managing the inputted telephone number based on a corresponding relation between telephone numbers and the respective providers, and which reads an initial setup data corresponding to the specified provider from the storage unit, and an output unit which outputs the initial setup data read by the selection unit.

### BACKGROUND OF THE INVENTION

The present invention relates to an IP telephone device capable of conveniently performing an initial setup, and a method of initial setting of the ID telephone device and a computer-readable recording medium.

An Internet Protocol (IP) telephone using Internet is widely spread. Since the IP telephone is identified by an IP address assigned on the Internet, a called party's IP address should be known for call connection. IP telephone providers manage corresponding relations between subscribers' IP telephone numbers and IP addresses by recording them in a database. Such a management of the IP addresses is described in JP-A-2003-158553. In addition, JP-A-2003-158553 discloses a method of rapidly performing a call setup by retrieving IP addresses in a short time.

By the way, an initial setup determined by a provider should be performed for an IP telephone when an user starts to use the IP telephone. There has been a problem in that since the IP telephone provider belongs to any one of groups and accordingly different setup procedures are needed for individual groups. As a result, it is difficult to find out how to make the initial setup.

For example, when a single Internet provider provides a plurality of IP telephone services which belong to different groups, it is difficult for a user to find out how to make the initial setup. Further, when a user selects an incorrect group during an initial setup procedure, a proper connection is not established.

Although there are the above-mentioned difficulties in performing an initial setup, there has not been provided a device which can solve the above-mentioned initial setup problem, so that the use must solve the above-mentioned initial setup problem by operating the initial setup.

### SUMMARY OF THE INVENTION

It is an object of the present invention to provide an IP telephone device, a method of initial setting of the ID telephone device and a computer-readable recording medium that enable a user to conveniently perform an initial setup by making it possible to select a correct IP telephone provider.

In order to achieve the above object, according to the present invention, there is provided an IP telephone device comprising:

a storage unit which stores a plurality of initial setup data corresponding to respective providers;

an input unit which input a telephone number;

a selection unit which specifies a provider managing the inputted telephone number based on a corresponding relation between telephone numbers and the respective providers, and which reads an initial setup data corresponding to the specified provider from the storage unit; and

an output unit which outputs the initial setup data read by the selection unit.

The IP telephone device further comprises a setup unit which performs an initial setup process based on input data which is inputted in response to the initial setup data outputted by the output unit. The initial setup data is an initial setup screen. The corresponding relation between the telephone numbers and the respective providers is formed in a table form.

The IP telephone device further comprises a provider accessing unit which specifies a provider corresponded to a called party's telephone number inputted upon calling based on the corresponding relation between the telephone numbers and the respective providers, and which performs a process of accessing to the specified provider, in this case, it is possible to select a common provider, thereby reducing telephone charges.

The corresponding relation is further corresponded the respective provides to groups to which the respective providers are belonged. The provider accessing unit specifies a group corresponded to the called party's telephone number inputted upon calling based on the corresponding relation between the telephone numbers, the respective providers and the groups, and performs a process of accessing to the provider which belongs to the specified group. This is suitable for a case where providers divided into groups give their services.

According to the present invention, there is also provided a method of initial setting of an IP telephone device, comprising:

inputting a telephone number;

specifying a provider managing the inputted telephone number based on a corresponding relation between telephone numbers and respective providers;

reading an initial setup data corresponding to the specified provider from the storage unit which stores a plurality of initial setup data corresponding to the respective providers;

outputting the initial setup data read from the storage unit.

The method, further comprising:

performing an initial setup process based on input data which is inputted in response to the outputted initial setup data.

The method, further comprises:

specifying a provider corresponded to a called party's telephone number inputted upon calling based on the corresponding relation between the telephone numbers and the respective providers; and

performing a process of accessing to the specified provider.

The corresponding relation is further corresponded the respective provides to groups to which the respective providers are belonged.

The method further comprises:

specifying a group corresponded to the called party's telephone number inputted upon calling based on the corresponding relation between the telephone numbers, the respective providers and the groups; and

performing a process of accessing to the provider which belongs to the specified group.

A computer-readable recording medium for causing a computer to execute the method of initial setting of an IP telephone device according to any one of the above features.

According to non limited embodiment of the present invention, when a user inputs his/her telephone number, an initial setup data for a provider corresponding to the inputted telephone number is automatically selected. Accordingly, the user can make a correct initial setup through the initial setup data.

Further, according to a more preferred non limited embodiment of the present invention, it is possible to reduce telephone charges since a user can select the same as a provider to which a called party belongs, or can select a provider belonging to the same as a group to which another provider associated with the called party belongs.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a construction of a first embodiment of the present invention;

FIG. 2 is a view showing contents stored in a table (TBL) according to the first embodiment of the present invention;

FIG. 3 is a view showing a start screen for initial setup according to the first embodiment of the present invention;

FIG. 4 is a view showing an example of an initial setup screen according to the first embodiment of the present invention;

FIG. 5 is a view showing another example of an initial setup screen according to the first embodiment of the present invention;

FIG. 6 is a view showing another example of an initial setup screen according to the first embodiment of the present invention;

FIG. 7 is a block diagram showing a construction of a second embodiment of the present invention; and

FIG. 8 is a view showing contents stored in a table (TBL) according to the second embodiment of the present invention.

### DETAILED DESCRIPTION OF THE PREFERRED EMBODIMENTS

[A. First Embodiment]

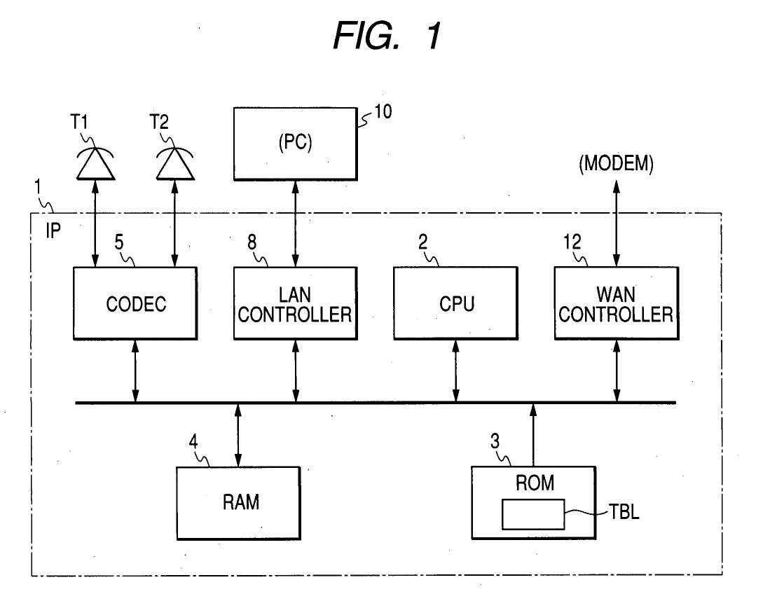

FIG. 1 is a block diagram showing a construction of an IP telephone router (IP telephone device) according to a first embodiment of the present invention. Reference numeral 1 denotes an IP telephone router. Reference numeral 2 denotes a CPU which runs based on programs stored in ROM 3 and controls each unit. Reference numeral 4 denotes RAM used as a work area for the CPU 2. Further, ROM 3 stores various kinds of tables or screen data for initial setup, in addition to the programs used in the CPU 2.

Reference numeral 5 is a codec for compressing and decompressing signals between telephones T1 and T2 and CPU 2. The codec 5 digitizes a voice signal or dial-tone signal sent from the telephones T1 and T2, and compresses the digitized signal into a predetermined format of digital signal. In addition, the codec 5 decompresses a compressed digital signal applied from CPU 2 into an analog signal, and supplies the analog signal to the telephones T1 and T2. While the codec 5 can be connected to a plurality of telephones, the codec 5 in the present embodiment is connected to two telephones T1 and T2.

Next, reference numeral 8 denotes a LAN controller which has a plurality of Ethernet terminals. The LAN controller 8 transmits/receives signals between devices connected to the Ethernet terminals and the CPU 2. In FIG. 1, a personal computer (hereinafter referred to as ‘PC’) 10 is connected to the LAN controller 8. Reference numeral 12 denotes a WAN controller which transmits/receives signals to/from a modem (not shown). The CPU 2 is connected to Internet via the WAN controller 12 and the modem.

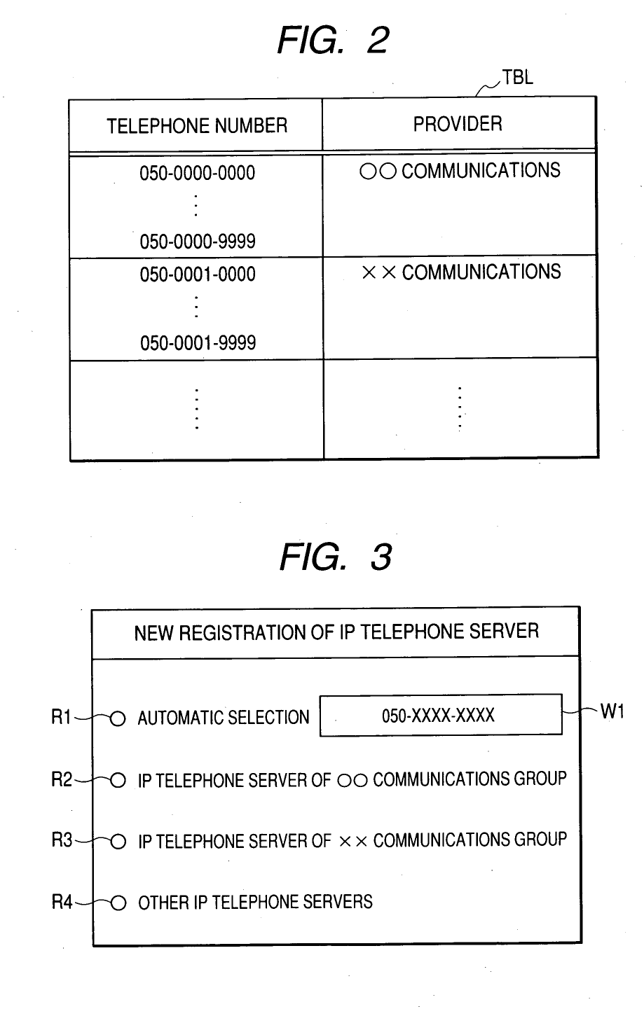

FIG. 2 is a view showing a table TBL stored in ROM 3. As shown in FIG. 2, a corresponding relation between telephone numbers and providers is recorded in the table TBL. In FIG. 2, telephone numbers ranging from 050-0000-0000 to 050-0000-9999 correspond to oo communications, and telephone numbers ranging from 050-0001-0000 to 050-0001-9999 correspond to XX communications. That is, in the present embodiment, the providers are specified by a range of telephone numbers (i.e., starting and closing numbers of a sequence of consecutive numbers). This is because telephone numbers assigned to the providers are usually consecutive numbers. While the table TBL of FIG. 2 shows a correspondence to two providers, the table TBL actually shows a correspondence to the number of providers.

Operation of the above-mentioned construction according to the present embodiment will now be described. First, a user operates the PC 10 to execute a browser and inputs a predetermined URL. The URL is one that specifies hardware of the IP telephone router 1 and represents an HTML file corresponding to a first page (start screen) of an initial setup screen stored in ROM 3. The user can obtain the URL from an instruction manual of the IP telephone router 1.

When the URL is inputted from the PC 10, the CPU 2 of the IP telephone router 1 identifies the URL, reads the start screen in ROM 3, and sends the start screen to the PC 10. As a result, a screen shown in FIG. 3 is displayed in the PC 10. In the screen shown in FIG. 3, an item ‘New Registration of IP Telephone Server’ is displayed on a top side and initiation of an initial setup procedure is known to the user. In addition, items ‘Automatio Selection’, ‘oo Communications’, ‘XX Communications’, and ‘Other IP Telephone Servers’ are displayed on the center of the screen, and radio buttons R1 to R4 are displayed on a left side of each of the items. The radio buttons R1 to R4 are turned on by clicking with a mouse or the like, which shows that a corresponding item has been selected. Further, a window W1 for inputting a telephone number is displayed on the right side of the item ‘Automatic Selection’.

In this case, when the user clicks on the radio button R1, a corresponding signal is applied to the CPU 2, whereby the CPU 2 can obtain information that the item ‘Automatic Selection’ is selected. The CPU 2 enables the user to input a telephone number into the window W1. Next, the user inputs his/her telephone number into the window W1.

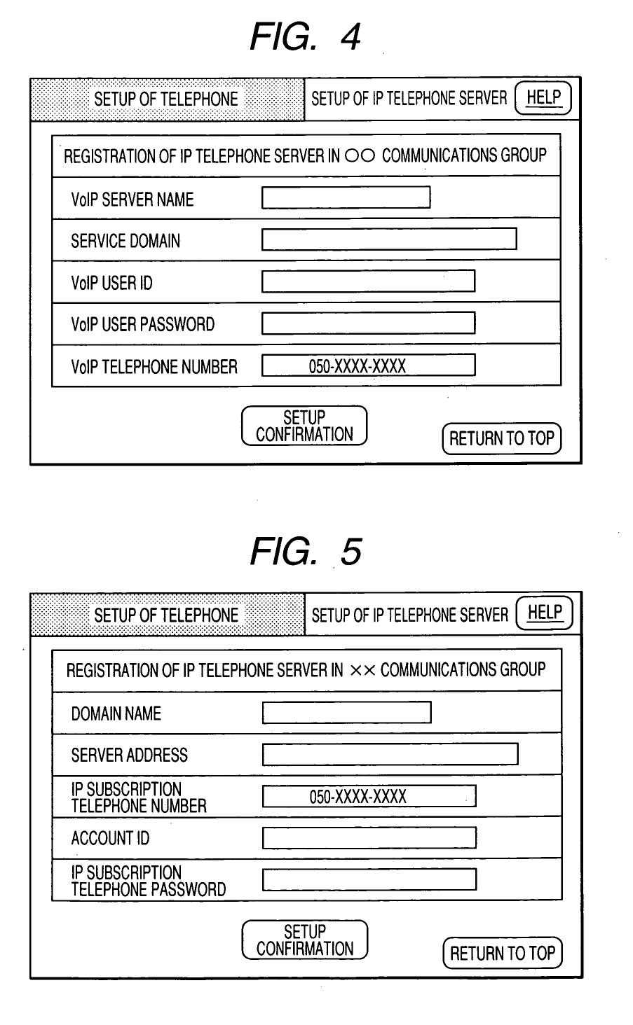

The telephone number inputted by the user is supplied to the CPU 2, and the CPU 2 specifies a provider by making reference to the table TBL in ROM 3. That is, if the telephone number inputted by the user is 050-0000-9879, the CPU 2 can obtain information that a selected provider is oo communications by making reference to the table TBL shown in FIG. 2. As a result, the CPU 2 reads an initial setup screen of the oo communications from ROM 3 and sends the initial setup screen to the PC 10. By doing so, an initial setup screen shown in FIG. 4 is displayed in the PC 10. Referring to FIG. 4, an item ‘Registration of IP telephone server associated with oo communications’ is displayed on an upper side of the center of the screen so that the user can know that the screen is one for setup of oo communications. Below the item, items ‘VoIP Server Name’, ‘Service Domain’, ‘VoIP User ID’, and ‘VoIP User Password’ are displayed. On the right side of each of the items, a window for inputting a related fact is displayed. The inputted telephone number in FIG. 3 is already displayed in a window for the item ‘VoIP Telephone Number’.

When the user inputs respective items and then clicks on the ‘setup confirmation’ button displayed on a lower side of the screen, the CPU 2 performs an initial setup based on the inputted items. In view of the above, when the user inputs his/her telephone number, the initial setup screen for a provider corresponding to the inputted telephone number is automatically selected and displayed, whereby the user can perform a correct initial setup.

Meanwhile, when a user's telephone number inputted into the window W1 shown in FIG. 3 is 050-0001-3953, the CPU 2 identifies a provider of the telephone number as XX communications by making reference to the table TBL in ROM 3 (see FIG. 2). The CPU 2 reads an initial registration screen of the XX communications in ROM 3 and sends the initial registration screen to the PC 10. As a result, an initial setup screen shown in FIG. 5 is displayed in the PC 10. The initial setup screen shown in FIG. 5 is the same as the initial setup screen shown in FIG. 4 in the function except that individual item names are different from each other since respective providers are not identical. That is, the item names shown in FIG. 5 are ‘Domain Name’, ‘Server Address’, ‘IP Subscription Telephone Number’, ‘Account ID’, and ‘IP Subscription Telephone Password’. As will be seen from a comparison between FIG. 4 and FIG. 5, different item names are displayed in the screens for different providers. This causes a user to make an incorrect initial setup. However, according to the present embodiment, a correct provider is automatically selected when a telephone number is inputted. In addition, the inputted telephone number in the screen shown in FIG. 3 is automatically displayed in the window of ‘IP subscription telephone number’.

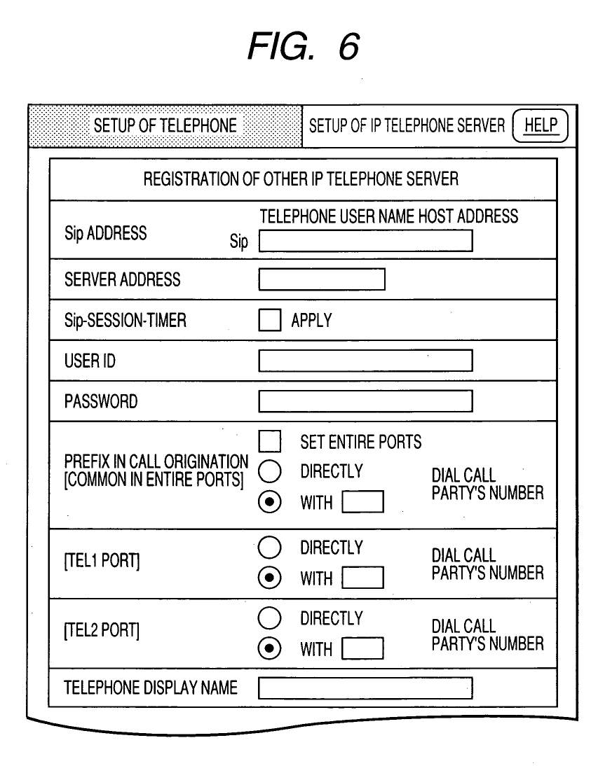

Further, when a user's telephone number inputted into the window W1 shown in FIG. 3 does not correspond to any number in the table TBL, the CPU 2 reads an initial setup screen shown in FIG. 6 from ROM 3 and sends the initial setup screen to the PC 10. The initial setup screen shown in FIG. 6 is one that can be universally used.

When one of radio buttons R2 to R4 corresponding to ‘oo Communications’, ‘XX Communications’, and ‘Other IP Telephone Server’ is pressed in the start screen shown in FIG. 3, an initial setup screen corresponding to each item, i.e., one of the initial setup screens shown in FIGS. 4, 5, and 6, is immediately displayed in the PC 10.

[B. Second Embodiment]

A second embodiment of the present invention will now be described. A hardware construction of the second embodiment is almost the same as that of the first embodiment, except that two WAN controllers 12 are provided for making it possible to perform an initial setup for two providers.

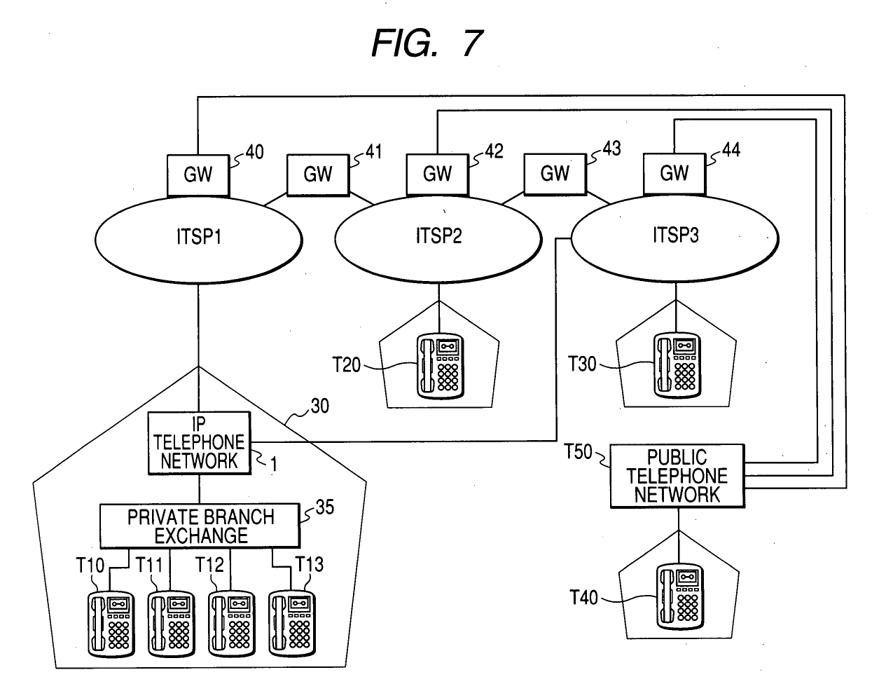

FIG. 7 is a block diagram of the second embodiment. Referring to FIG. 7, the IP telephone router 1 according to the second embodiment is provided in a building 30. The IP telephone router 1 is connected to providers ITSP1 and ITSP3. A modem is not shown in FIG. 7. In addition, the providers ITSP1 and ITSP2 belong to the same group A, and the provider ITSP3 belongs to a different group B.

In FIG. 7, reference numeral 35 denotes a private branch exchange which is connected to a plurality of telephones T11, T12, T13, and T14. The telephones T11, T12, T13, and T14 are connected to the private branch exchange 35 and the IP telephone router 1. Reference numeral 50 denotes a public telephone network to which fixed telephones are connected. A telephone T40 is connected to the public telephone network 50. IP telephone service providers ITSP1, ITSP2, and ITSP3 can communicate with the public telephone network 50 through gateways 40, 42, and 44, respectively. In addition, the providers ITSP1 and ITSP2 can communicate through a gateway 41, and the providers ITSP2 and ITSP3 can communicate through a gateway 43. Further, the providers ITSP1 and ITSP3 can communicate through a gateway, which is not shown.

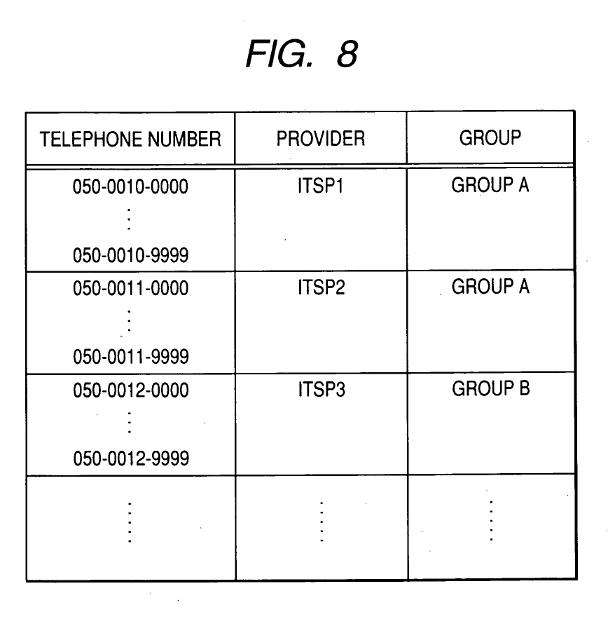

FIG. 8 shows contents contained in a table TBL according to the second embodiment. As shown in FIG. 8, the table contains a corresponding relation between a range of telephone numbers and providers, and a group name associated with each provider.

Next, operation of the second embodiment will be described. An initial setup operation of the second embodiment is the same as that of the first embodiment. The second embodiment is characterized by a call process after an initial setup. The call process will now be described.

Suppose that a user of a telephone T10 calls a called party. The CPU 2 specifies a provider under contract with the called party and identifies a group name of the provider by making reference to the called party's telephone number and the table TBL. For example, if the called party is a telephone T20 and the telephone number is 050-0011-3344, the CPU 2 determines that the provider under contract with the called party is ITPS2 and belongs to group A by making reference to the table TBL. As a result, the CPU 2 selects the WAN controller 12 (see FIG. 1) connected to the provider ITPS1 for communications. The telephone T10 can communicate with the telephone T20 through the provider ITSP1, the gateway 41, and the provider ITPS2.

Meanwhile, suppose that a user of a telephone T11 calls to a telephone T30 whose number is 050-0012-4456. When the telephone number is sent to the CPU 2, the CPU 2 identifies that the number belongs to the provider ITSP3 which belongs to group B by making reference to the table TBL. As a result, the CPU 2 selects the WAN controller 12 connected to the provider ITSP3 for communications. Accordingly, the telephone T11 can communicate with the telephone T30 through the provider ITSP3.

Further, when the called party's telephone is a fixed telephone, the CPU 2 selects any one of two WAN controllers 12 (e.g., WAN controller not in use) for communications.

As described above, in accordance with the present embodiment, when using an IP telephone, a user can select a provider belonging to the same as a group to which another provider under contract with a called party belongs. Since a telephone call within the same group is generally free of charge, a user can significantly reduce telephone charges.

In the present embodiment, a user accesses a provider belonging to the same as a group to which another provider under contract with a called party belongs. However, the user can access a provider under contract with the called party. In this case, information about the group is not necessary in the table TBL.

[C. Modified Embodiments]

While the present invention has been described with reference to the above-mentioned embodiments, the present invention can be implemented in different forms without being limited to the above-mentioned embodiments. For example, the above-mentioned embodiments can be modified as follows.

While the above-mentioned embodiments are implemented using the IP telephone router, an IP telephone equipped with the same function may be used. Also, an IP telephone adapter for relaying between a modem (e.g., ADSL modem or optical fiber modem) and a telephone may be equipped with the above-mentioned function. Also, the IP telephone adapter may be equipped with modem function. Further, the IP telephone router used in the above-mentioned embodiments may be equipped with a modem.

While an initial setup is performed by using the PC 10 connected to the LAN controller 8 in the above-mentioned embodiments, the initial setup may be performed by using a telephone rather than the PC 10. That is, items can be inputted by using dial-tone signals of the telephone. In this case, the inputted items are displayed in a liquid crystal display of a main body of the telephone. Also, when a telephone is provided with a liquid crystal display, the items may be displayed in the telephone. For example, the items may be sequentially inputted one by one. Numerals or alphabets are inputted as the dial-tone signals. When the alphabets are input, a program for converting dial-tone signals into alphabets may be incorporated in the main body or telephone.

While a plurality of WAN controllers 12 are provided so that there exists a plurality of physical telephone circuits in the second embodiment, a single physical telephone circuit and a plurality of logical telephone circuits may be provided. For example, a plurality of logical telephone circuits is established by establishing a plurality of PPPoE (PPP over Ethernet (registered trademark)) sessions. Also, a plurality of logical telephone circuits is established in IP level by establishing a single PPPoE session.

While the table TBL shown in the above-mentioned embodiments is unchangeably written into ROM 3, the table TBL can be configured to be rewritten when a range of telephone numbers assigned to a provider is changed or new providers are registered. The provider can directly rewrite the table in online.

When the initial setup screen, which is universally used, shown in FIG. 6 is also used for initial setup for a plurality of providers, items unnecessary to selected providers may be deleted from the screen.

In the table TBL of the above-mentioned embodiments, providers are specified by the starting and closing numbers of a sequence of consecutive numbers. However, the present invention is not limited thereto, but it is possible as long as the providers can be specified. For example, if a provider can be specified by a number in a predetermined location, correspondence between the number in a predetermined location and the provider may be recorded.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2004-109075 filed on Apr. 1, 2004, the contents of which are incorporated herein for reference.

1. An IP telephone device, comprising:
a storage unit which stores a plurality of initial setup data corresponding to respective providers;
an input unit which input a telephone number;
a selection unit which specifies a provider managing the inputted telephone number based on a corresponding relation between telephone numbers and the respective providers, and which reads an initial setup data corresponding to the specified provider from the storage unit; and
an output unit which outputs the initial setup data read by the selection unit.

2. The IP telephone device as set forth in claim 1, further comprising a setup unit which performs an initial setup process based on input data which is inputted in response to the initial setup data outputted by the output unit.

3. The IP telephone device as set forth in claim 1, wherein the initial setup data is an initial setup screen.

4. The IP telephone device as set forth in claim 1, wherein the corresponding relation between the telephone numbers and the respective providers is formed in a table form.

5. The IP telephone device as set forth in claim 1, further comprising a provider accessing unit which specifies a provider corresponded to a called party's telephone number inputted upon calling based on the corresponding relation between the telephone numbers and the respective providers, and which performs a process of accessing to the specified provider.

6. The IP telephone device as set forth in claim 5, wherein the corresponding relation is further corresponded the respective provides to groups to which the respective providers are belonged; and
wherein the provider accessing unit which specifies a group corresponded to the called party's telephone number inputted upon calling based on the corresponding relation between the telephone numbers, the respective providers and the groups, and which performs a process of accessing to the provider which belongs to the specified group.

7. A method of initial setting of an IP telephone device, comprising:
inputting a telephone number;
specifying a provider managing the inputted telephone number based on a corresponding relation between telephone numbers and respective providers;
reading an initial setup data corresponding to the specified provider from the storage unit which stores a plurality of initial setup data corresponding to the respective providers;
outputting the initial setup data read from the storage unit.

8. The method as set forth in claim 7, further comprising:
performing an initial setup process based on input date which is inputted in response to the outputted initial setup data.

9. The method as set forth in claim 7, further comprising:
specifying a provider corresponded to a called party's telephone number inputted upon calling based on the corresponding relation between the telephone numbers and the respective providers; and
performing a process of accessing to the specified provider.

10. The method as set forth in claim 9, wherein the corresponding relation is further corresponded the respective provides to groups to which the respective providers are belonged, and
the method further comprising:
specifying a group corresponded to the called party's telephone number inputted upon calling based on the corresponding relation between the telephone numbers, the respective providers and the groups; and
performing a process of accessing to the provider which belongs to the specified group.

11. A computer-readable recording medium for causing a computer to execute the method of initial setting of an IP telephone device according to any one of claims 7 to 10.
